(19) United States
(12) Patent Application Publication
(10) Pub. No.: US 2013/0038895 A1
(43) Pub. Date: Feb. 14, 2013

(54) MOBILE COMMUNICATION DEVICE AND PRINTER HAVING A PARTICULATE SENSOR FOR AIR QUALITY MONITORING

(71) Applicants: Alexander GOVYADINOV, Corvallis, OR (US); Pavel Cornilovich, Corvallis, OR (US); Tommy D. Deskins, Albany, OR (US)

(72) Inventors: Alexander GOVYADINOV, Corvallis, OR (US); Pavel Cornilovich, Corvallis, OR (US); Tommy D. Deskins, Albany, OR (US)

(21) Appl. No.: 13/204,814

(22) Filed: Aug. 8, 2011

(51) Int. Cl. G06F 3/12; H04W 4/14; H04W 88/02

(52) U.S. Cl. 358/1.15; 455/556.1; 455/466; 358/1.1

(57) ABSTRACT

A mobile communication device includes a wireless transceiver to provide voice communications and a particulate sensor that indicates the amount of particulates detected by the sensor. Control logic in the mobile communication device causes data indicative of the sensor signal to be transmitted through a wireless transceiver. A printer is also disclosed that includes a particulate sensor to monitor air quality at the printer.

### BACKGROUND

Air quality is a factor of personal and public health. Air may contain various contaminants such as dust, solid particulates, cigarette smoke, pollen, fibers, aerosols, etc. Air quality may be a problem inside a building, such as an office or home, or outside.

### BRIEF DESCRIPTION OF THE DRAWINGS

For a detailed description of exemplary implementations, reference will now be made to the accompanying drawings in which:

FIG. 1 shows a mobile communication device in accordance with an implementation;

FIG. 2 shows a mobile communication device in accordance with another implementation;

FIG. 3 shows a block diagram of a mobile communication device in accordance with an implementation;

FIG. 4 illustrates a network in accordance with an implementation;

FIG. 5 shows an example of a map overlaid with air quality information in accordance with an implementation;

FIG. 6 shows a method in accordance with an implementation;

FIGS. 7 and 8 show a printer in accordance with an implementation;

FIG. 9 includes a block diagram of a printer in accordance with an implementation; and

FIG. 10 shows a method in accordance with a printer-based implementation.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be, for example, through a direct electrical connection, through an indirect electrical connection via other devices and connections, through an optical electrical connection, or through a wireless electrical connection.

### DETAILED DESCRIPTION

In accordance with various embodiments, a mobile communication device is equipped with a particulate sensor that detects various particulates in the air such as pollen, dust, and the like. Because mobile communication devices are ubiquitous and readily capable of wireless communications with computing systems (e.g., servers, storage systems, on-line databases, etc.), mobile communication devices equipped with particulate sensors can be used to monitor air quality. Large numbers of mobile communication devices having such sensors means that air quality can be monitored over large geographic areas as desired. The server(s) that receives the air quality information from the individual mobile communication devices may aggregate, average and otherwise process the air quality data and may overlay the air quality information on a map.

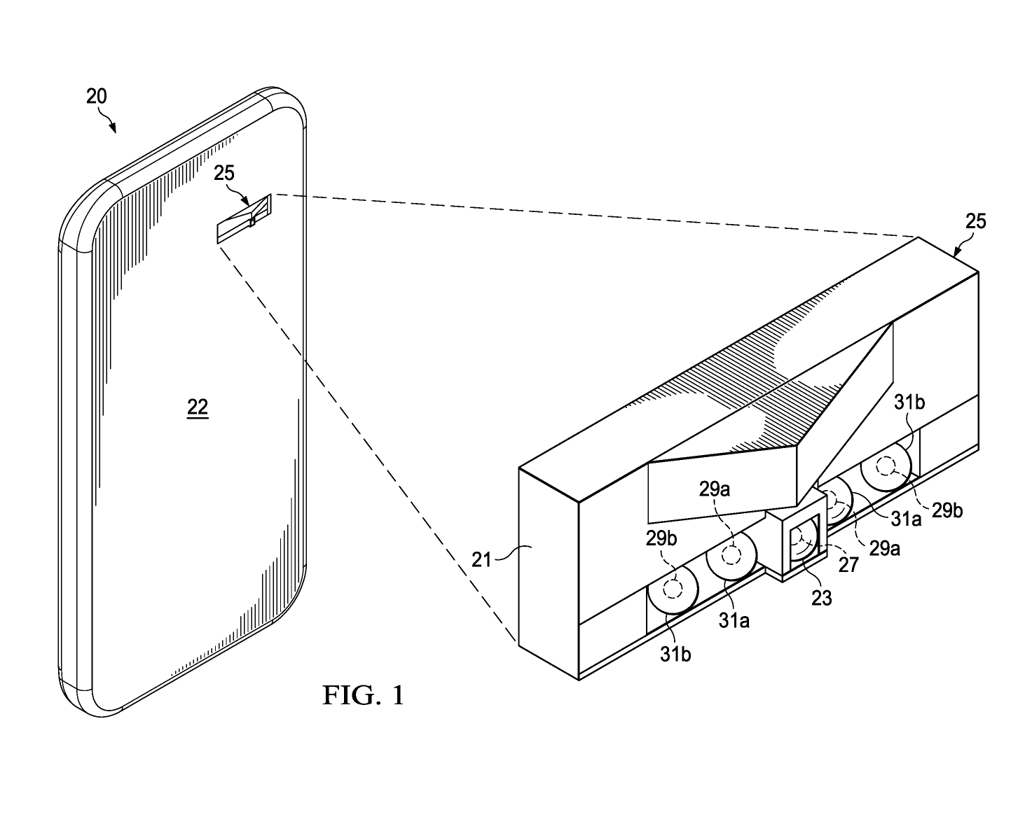

FIG. 1 shows an embodiment of a mobile communication device 20. The device 20 may be illustrative of a variety of mobile communication devices such as cellular telephones, smart phones, wireless personal digital assistants (PDAs), and the like. The mobile communication device 20 may also comprise a computer such as a notebook or laptop computer. In the embodiment of FIG. 1, a particulate sensor 25 is provided at an exterior surface 22 (e.g., a rear surface opposite a keypad and display, not shown) of a housing of the mobile communication device 20. As air blows past the sensor 25, the sensor detects the amount of particulates in the air.

The particulate sensor 25 may comprise a drop detector based on the light scattering principle (e.g., a backscattering drop detector). The sensor 25 may include a housing 21 containing a lens 23 which focuses light from a light source 27 (e.g., a light-emitting diode) to the desired location. The housing 21 also includes multiple lenses 31a and 31b in front of inner and outer light detectors 29a and 29b, respectively. Lenses 31a focus light from one space in the ink drop zone onto inner light detectors 29a, and lenses 31b focus from one space in the ink drop zone onto inner light detectors 29b.

In operation of the particulate sensor 25, light scatters off an air sample that contains particulates and is measured by the light detectors. In a “counting” mode of the sensor, each particulate produces a voltage spike. The particulates are counted one by one. In a “level” mode, the sensor's output signal (e.g., voltage) is indicative of the mean number of particulates in the air sample.

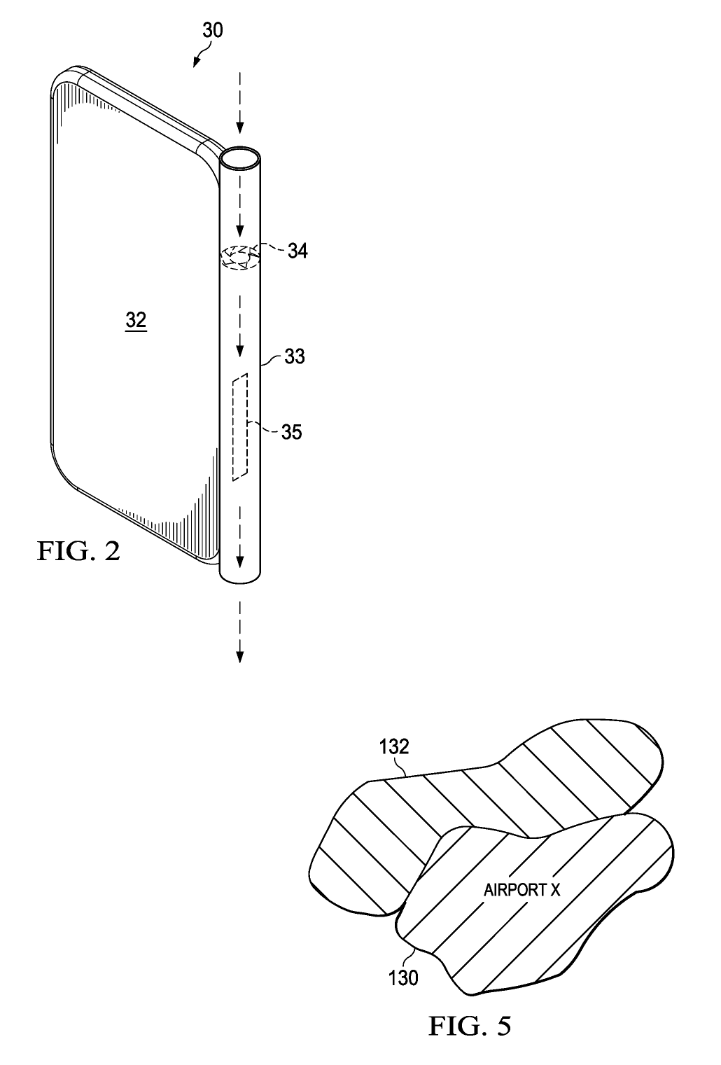

FIG. 2 shows an alternate embodiment of a mobile communication device 30. The mobile communication device 30 includes an air passage tube 33 inside which a particulate sensor 35 and a fan 34 are located. The fan 34 forces air in the direction of the arrows and past the sensor 35. The fan 34 may be driven by a vibration motor that the mobile communication device includes.

In the embodiment of FIG. 1, movement of the mobile communication device 20 relative to the surrounding air provides a sufficient air sample for an adequate sensor reading. In the embodiment of FIG. 2, because the sensor is contained within an air passage tube 33, the fan 34 ensures sufficient air flow for a sufficient sensor reading.

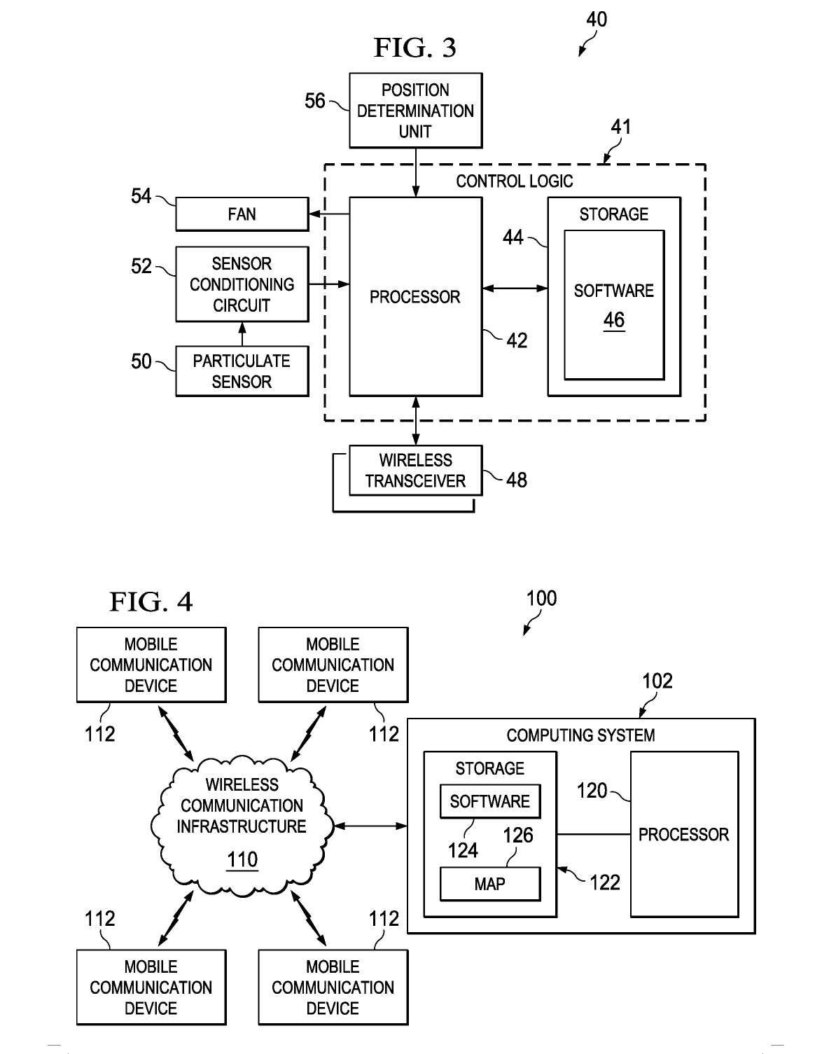

FIG. 3 shows a system block diagram of a mobile communication device 40 in accordance with various embodiments. The block diagram may be representative of either mobile communication device 20 of FIG. 1 or mobile communication device 30 of FIG. 2 (although mobile communication device 20 of FIG. 1 may not include a fan 54 as shown in FIG. 3). The block diagram includes control logic 41 which may be implemented in some embodiments as a processor 42 that executes software 46 stored on storage 44. Storage 44 comprises transitory storage such as random access memory (RAM), a hard disk drive, Flash storage, or combinations thereof. The control logic 41 (e.g., processor 42 and corresponding executable software 46) implements some or all of the functionality described herein as attributed to the mobile communication device 40.

One or more wireless transceivers 48 are included as well. Each wireless transceiver 48 is configured to wirelessly transmit and receive data. In some implementations, one transceiver 48 implements a cellular phone based protocol and another transceiver implements a shorter range wireless protocol such as any of the IEEE 802.11x family of protocols, Bluetooth, etc.

The mobile communication device 40 may also include a position determination unit 56. The position determination unit 56 is configured to determine or assist the control logic 41 in determining the location of the mobile communication device 40. In some implementations, a position determination unit comprises a satellite-based system such as the Global Positioning System (GPS). A satellite-based system can determine the absolute position of the mobile communication device (e.g., longitude and latitude). The position determination unit 56 also may comprise an inertial-based system capable of determining position relative to a known position. An inertial-based position determination unit 56 may comprise, for example, multiple (e.g., 3) accelerometers and multiple (e.g., 3) gyroscopes.

Sensor conditioning circuit 52 may be included in the mobile communication device 40 as desired to condition the signal from a particulate sensor 50 (as described above) for receipt by the control logic 41. The conditioning circuit 52 may include, for example, an amplifier and filter. The mobile communication device 40 is configured to take an air quality reading by, for example, the control logic 41 acquiring a signal from the particulate sensor 50 via the sensor conditioning circuit 52. The sensor signal is indicative of the amount of particulates detected by the sensor 50. The control logic 41 may further process the sensor signal. Such processing may include signal filtering, smoothing, enhancing, differentiation, discrimination, etc. The control logic 41 then generates and causes air quality data indicative of the sensor signal to be transmitted through a wireless transceiver 48 through the cellular network to a processing system such as a computer (e.g., a server).

In some implementations, the air quality data generated by the control logic 41 based on the sensor signal may include the sensor signal itself or may include data that has been generated using the sensor signal as an input. For example, the data may include information about particulate scattering cross-section (optical properties), size and velocity relative to the sensor.

The mobile communication device 40 also may timestamp the air quality data with an indication of when the sensor signal was acquired or transmitted via a transceiver 48. The timestamp may include, for example, a date, a time of day, or both. The mobile communication device 40 may also include with the air quality data the position of the mobile communication device 40 (as determined using position determination unit 56) when the sensor signal was acquired by the control logic 41.

The air quality data includes an indication of the quality of the air in the vicinity of the mobile communication device 40, and may also include a timestamp and/or the mobile communication device's position. The computing system (e.g., a server) that receives such data thereby may be informed of the air quality at a particular location and a time of day or date.

FIG. 4 illustrates a network 100 in which a computing system 102 communicates through a wireless communication infrastructure 110 with one or more mobile communication devices 112. Each mobile communication device 112 may be implemented in accordance with the block diagram of FIG. 3 and may be consistent with, for example, the implementations of FIG. 1 or 2.

Each mobile communication device 112 communicates its air quality data to the computing system 102 via the wireless communication infrastructure 110. The wireless communication infrastructure 110 may include one or more cellular phone base stations, network switches, routers, etc. The computing system 102 may be in wireless communication with the wireless communication infrastructure 110 or may have a wired connection to the infrastructure 110.

The computing system 102 may comprise a single computer or multiple computers networked together over, for example, a local area network (LAN). The computing system 102 may include one or more processors 120 coupled to storage 122 (e.g., random access memory, hard disk drive, Flash storage, etc.). The storage 122 contains software 124 that, when executed by the processor 120 provides the computing system 102 with some or all of its functionality. Map data 126 may also be included in storage 122.

In some implementations, the computing system 102 initiates the interaction with a mobile communication device 112 for the mobile communication device's air quality data. In such implementations, the computing system 102 transmits a request to a mobile communication device 112 and the mobile communication device replies with its air quality data. Alternatively, a mobile computing device 112 may initiate the interaction with the computing system 102. For example, a mobile communication device 112 may transmit a message to the computing system 102 that the mobile communication device 112 has air quality data to transmit, and the computing system 102 replies when it is ready to receive the air quality data. Further still, the initial message from the mobile communication device 112 may contain the air quality data itself. The computing system 102 may reply with an acknowledgment that the air quality data was successfully received.

The computing system 102 may process and use the received air quality data in any of a variety of ways. For example, the computing system 102 may combine air quality data from the various mobile communication devices 112. Combining the air quality data may include aggregating the data, averaging the data, or performing any other suitable type of statistical processing on the data. The computing system 102 may compare the received air quality data to a threshold and generate an alert based on the data. For example, if the air quality as indicated by the air quality data received from one or more mobile communication devices exceeds a predetermined threshold, the computing system 102 may generate an alert to indicate a possible unsafe environmental condition. The alerts may comprise such forms as an email, a text message, etc. sent to the mobile communication devices 112 whose air quality data led to the alert in the first place. An alert can also be provided to a person (e.g., a health official) who can respond to the potential problem in any suitable manner.

As noted above, the computing system's storage 122 may include map data 126. The map data 126 identifies various locations by, for example, longitude and latitude and the like. If cases in which the air quality data received from a mobile communication device 112 includes the position of mobile communication device, the computing system 102 may overlay the air quality data on the map data. As such, an air quality map is produced that shows the air quality at various geographical regions.

In some implementations, the air quality data is translated to a color or gray scale. For example, green may mean acceptable air quality (relative to a corresponding threshold), while red may mean air quality outside the acceptable range (relative to the threshold). Various colors or gray scales may be used to depict varying degrees of air quality. Such colors or gray scales may be superimposed on the map data to present a readily viewable depiction of air quality.

FIG. 5 shows an example of a portion of a map around an airport. The map illustrated in FIG. 5 shows two cross-hatched areas 130 and 132. Each cross-hatched area may represent a different color, a different gray scale, or just different styles of cross-hatching as shown. Each such area 130 and 132 corresponds to a particular air quality level, and the air quality level of area 130 is different (higher or lower) than the air quality of area 132.

Monitoring the air quality in the vicinity of a mobile communication device 20, 30 that is located in a purse, a briefcase, a suitcase, a pocket, etc. may be of little benefit. Thus, in some implementations the mobile communication device acquires the sensor signal upon initiation of a communication. For example, when a phone call is made, an incoming phone call is answered, an email is sent or read, a text message is sent or read, etc the control logic 41 takes an air quality reading from the sensor 50 at that time.

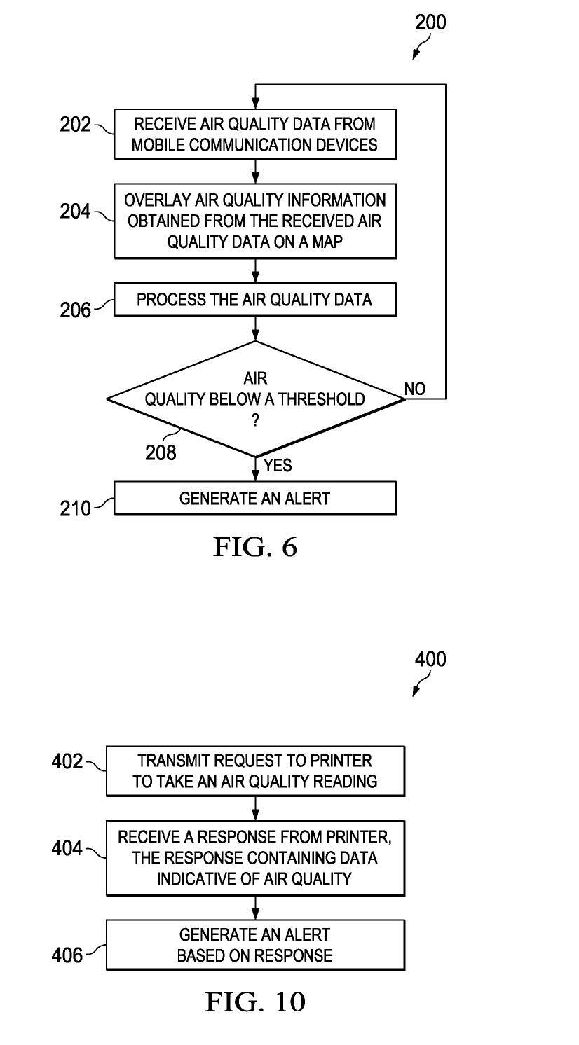

FIG. 6 shows a method 200 implemented by, for example, computing system 102. The various actions depicted in FIG. 6 may be performed in the order shown or in a different order. Further, two or more of the actions may be performed in parallel rather than serially.

At 202, the method comprises the computing system 102 receiving air quality data from one or more mobile communication devices 112. At 204, the method comprises the computing system 102 overlaying the air quality information obtained from the received air quality data on a map. The method further comprise the computing system 102 processing the air quality data (e.g., aggregating the data, averaging the data, etc.). The air quality data, or the data after being processed, is compared to a threshold at 208 and an alert is generated at 210 based on the comparison to the threshold. The alert may include a text message, email, audible alarm, visual alarm, etc.

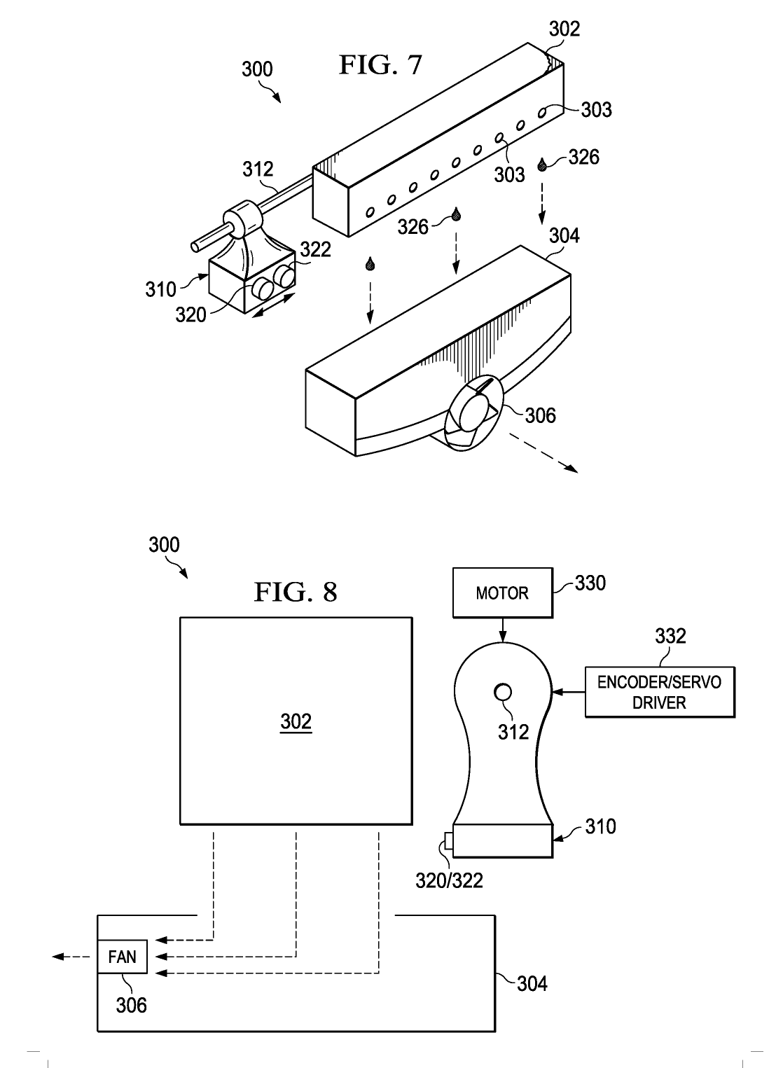

Other embodiments are directed to a printer that includes a particulate sensor usable to monitor air quality at or near the printer. FIGS. 7-9 illustrate an implementation of a printer 300 that includes a particulate sensor 310. FIG. 7 shows a printhead 302 that ejects drops 326 of ink onto a sheet of print media (not specifically shown) that passes between the printhead 302 and a platen 304. The platen 304 includes a fan 306 that causes air to flow along the direction of the arrows in FIGS. 7 and 8, thereby creating some degree of suction. The suction helps to prevent contamination of the backside of the print media that might occur from any ink drops that sit on the platen 304. The suction created by fan 306 forces extraneous drops of ink through the platen 304 and away from the print media.

The particulate sensor 310 hangs from a rail 312 and can be moved back and forth along the rail 312 by a motor 330. An encoder/servo driver 332 provides a feedback signal to the motor 330 to control the speed and location of the sensor 310. The particulate sensor 310 includes a light source 320 and a photodetector 322. Light from the light source 320 is scattered off various particulates (e.g., ink drops, dust, pollen) in the air in front of the sensor and is received into the photodetector. The received scattered light can be monitored to determine the number of particulates.

The particulate sensor 310 can be used to monitor the health and status of the various nozzles 303 comprising the printhead 302. For example, a printhead in service position dispenses drops from nozzles. Scanning by the sensor along the nozzle area detects reflected light from the droplets which indicates properly operating nozzles. The absence of scattered light from expected droplets indicates one or more malfunctioning or missing nozzles.

The particulate sensor 310 also can be used to monitor air quality in general in the vicinity of the printer 300. Air quality monitoring may be performed when the printer 300 is not printing a document (i.e., during idle times).

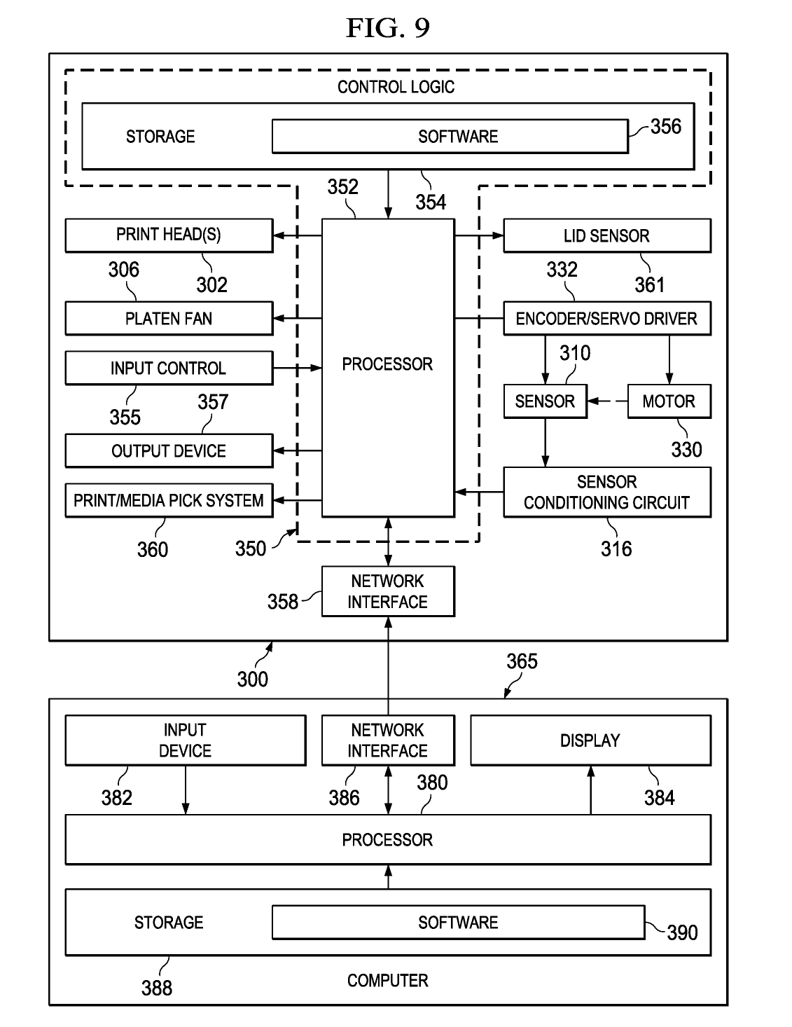

FIG. 9 illustrates a block diagram of printer 300 coupled to a computer 365. The printer 300 comprises control logic 350 coupled to one or more printheads 302, the platen fan 306, the encoder/servo driver 332, one or more input controls 355 (e.g., buttons), an output device 357 (e.g., a display), a print media pick system 360, a lid sensor 361, and a network interface 358. The particulate sensor 310 also couples to the control logic 350 through a sensor conditioning circuit 316 in some implementations. The sensor conditioning circuit 316 may comprise an amplifier and/or a filter to condition the electrical signal from the sensor 310 suitable for reading and using by the control logic 350.

The control logic 350 may comprise a processor coupled to non-transitory storage 354. The storage 354 comprises one or more storage devices such as random access memory (RAM), read only memory (ROM), a hard disk drive, Flash storage, and the like. The storage 354 includes software 356 that is executable by the processor 352. The processor 352, executing software 356, performs some or all of the functionality described herein as attributed to the control logic 350.

The network interface 358 may comprise a wireless interface (e.g., IEEE 802.11x, BlueTooth, etc.) or a wired network interface controller (NIC) that permits the printer 300 to communicate with a computer 365. Computer 365 may comprise a processor 380 coupled to an input device 382 (e.g., mouse, keyboard, etc.), a display 384, a network interface 386, and storage 388. Storage 388 comprises one or more storage devices such as random access memory (RAM), read only memory (ROM), a hard disk drive, Flash storage, and the like. The storage 388 contains software that is executable by the processor and, when executed by the processor 380, provides the computer 365 with some or all the functionality described herein as attributed to the computer.

The printheads 302 are controlled by control logic 350 to eject drops of certain color ink at precisely controlled times to form images on print media that has been picked by a print media pick system 360. In some implementations, the print media pick system 360 comprises a motor, one or more gears, and one or more pick wheels. The control logic 350 activates the print media pick system 360 to turn the pick wheels which contact the print media in a tray thereby to extract a sheet of print media from the tray and route the print media through the printer for printing by the printheads 302.

Air quality monitoring is activated through the control logic and may be activated manually or automatically. Manual activation of air quality monitoring by printer 300 may include a user activating an input control 355 on the printer to force activation of air quality monitoring using particulate sensor 310 or by a user of the external device 365 entering a command on computer 365 which then commands control logic 350 in the printer 300 to initiate air quality monitoring using sensor 310. Further still, the printer includes a lid sensor 361 that signals the control logic 350 when a lid of the printer is in an open position (e.g., a user opening the lid to change out an ink cartridge). The control logic 350 may respond by taking a particulate reading from sensor 310 at that time.

Some implementations of the particulate sensor 310 require relative motion between the sensor and the air sample being monitored. Either the sensor moves relative to the air sample, or the air sample is blown across a stationary sensor. Both scenarios are possible with printer 300. The platen's fan 306 can be activated by the control logic 350 and when activated causes air to flow along the direction of the arrows in FIGS. 7 and 8 and thus across the face of the particulate sensor 310. Alternatively, the fan 306 may be turned or left off and the sensor 310 may be moved along rail 312 by the motor 330. The printer 300 also may perform air quality monitoring by both causing the sensor 310 to move and by creating air flow by activating fan 306.

The control logic 350 receives a signal from the sensor 310 via the sensor conditioning circuit 316 and processes the signal. The sensor's signal encodes the level of the number of particulates detected during the measurement. The control logic 350 may report that value on the output device 357. The control logic 350 alternatively may compare the value to one or more thresholds and generate and provide an alert based on the comparison. For example, if the value exceeds a threshold, a message may be displayed on output device 357. The message may indicate that the air quality is deemed unsatisfactory or that the air quality is deemed satisfactory. The value derived from the particulate sensor 310 may be compared to multiple thresholds to indicate, for example, the quality of the air (e.g., on a scale of 1-5 or excellent/good/unsatisfactory/poor, etc.).

The control logic 350 may also communicate information indicative of the determined air quality through the network interface 358 to computer 365 for presentation to a user (e.g., a pop-up window on display 384, an email alert, etc.).

FIG. 10 illustrates a method 400 implemented on computer 365 (e.g., by processor 380 executing software 388) in accordance with some implementations. At 402, the computer 365, either by manual input by a user or by a scheduled event, transmits a request to the printer 300 for the printer to take an air quality reading using its particulate sensor 310. After the printer 300 takes the reading, at 404 the computer 365 receives a response from the printer. The response contains data that is indicative of the air quality as determined by the printer 300. At 406, the computer 365 generates an alert based on the response. For example, if the air quality data indicates unsatisfactory air quality, a pop-up alert window may be displayed on display 384 or an email may be generated and sent to a predetermined email address. In other embodiments, the computer 365 provides air quality feedback to the user of computer even if the air quality is satisfactory.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A mobile communication device, comprising:
a wireless transceiver to provide communications;
a particulate sensor; and
control logic coupled to said particulate sensor and said wireless transceiver, said control logic to acquire a sensor signal from said sensor, said sensor signal indicative of an amount of a characteristic of particulate detected by said sensor.

2. The mobile communication device of claim 1 further comprising a location determination unit, and said data transmitted through said wireless transceiver is indicative of the sensor signal as well as a location of said mobile communication device as determined by said location determination unit.

3. The mobile communication device of claim 1 further comprising a fan configured to move air across said sensor, and wherein said control logic activates said fan upon said control logic acquiring said sensor signal.

4. The mobile communication device of claim 1 wherein said control logic acquires said sensor signal upon initiation of a voice communication.

5. The mobile communication device of claim 1 wherein said particulate sensor comprises a back scattering drop detector.

6. A computing system, comprising:
a processor to receive data from a plurality of mobile communication devices, said mobile communication devices configured to provide voice communications;
wherein said data being indicative of air quality.

7. The computing system of claim 6 wherein said processor causes air quality information obtained from said data to overlay a map.

8. The computing system of claim 6 wherein said processor generates an alert based on said data.

9. The computing system of claim 6 wherein said processor causes a text message or email to be transmitted to at least one of said plurality of mobile communication devices, said text message or email indicative of said air quality.

10. A printer, comprising:
a printhead;
a particulate sensor; and
control logic coupled to said printhead and said particulate sensor, said control logic to receive a particulate sensor signal from said particulate sensor, said data being indicative of the air particulate sensor signal;
wherein said sensor operative, when the printer is in a printing mode, to detect a characteristic of ink drops ejected by the printhead, and operative, when the printer is in a non-printing mode, to detect a characteristic of particulate in the air in or around the printer.

11. The printer of claim 10 further comprising a lid sensor that detects when a lid of said printer is in an open position, and wherein said processor receives a lid signal from said lid sensor and, based on detection that the lid is open, said control logic receives said air particulate sensor signal.

12. The printer of claim 10 further comprising a display, wherein said control logic is configured to cause an alert to be provided on said display based on said air particulate sensor signal.

13. The printer of claim 10 wherein said control logic is configured to compare said air particulate sensor signal to a threshold and generate an alert on the basis of the comparison.

14. The printer of claim 10 further comprising the control logic to transmit data indicative of the particulate sensor signal to a computer.

15. The printer of claim 10 further comprising a display and wherein the control logic is to display information indicative of the particulate sensor signal on said display.

16. The printer of claim 10 wherein said particulate sensor comprises a back scattering drop detector integrated into said printer.

17. A computer, comprising:
a processor; and
an interface configured to communicate with a printer;
wherein said processor receives data from the printer, the data being indicative of air quality.

18. The computer of claim 17 wherein said processor causes a command to be sent to the printer for an air quality reading to be taken by the printer.

19. The computer of claim 17 wherein said processor generates an alert based on said data received from the printer.

20. The computer of claim 17 wherein said alert comprises an email message or a pop-up window.

21. A non-transitory storage device containing software that, when executed by a processor, causes the processor to:
transmit a request to a printer, said request being for the printer to take an air quality reading;
receive a response from the printer, the response containing data indicative of air quality; and
generate an alert based on said response.

22. The non-transitory storage device of claim 21 wherein the software causes the processor to compare said data to a threshold, and to generate the alert on the basis of the comparison.

23. The non-transitory storage device claim 22 wherein the alert comprises an email message or a pop-up window.

24. The non-transitory storage device of claim 21 wherein said software also causes the printer to print a print job.
